(19) United States
(12) Patent Application Publication
(10) Pub. No.: US 2010/0121622 A1
(43) Pub. Date: May 13, 2010

(54) Systems and Methods for Computing and Validating a Variogram Model

(75) Inventors: Genbao Shi, Sugar Land, TX (US); Richard L. Chambers, Bixby, OK (US); Jeffrey M. Yarus, Houston, TX (US)

Correspondence Address: CRAIN, CATON & JAMES, FIVE HOUSTON CENTER, 1401 MCKINNEY, 17TH FLOOR, HOUSTON, TX, 77010, US

(73) Assignee: Landmark Graphics Corporation, a Halliburton Company, Houston, TX (US)

(21) Appl. No.: 12/605,945

(22) Filed: Oct. 26, 2009

Related U.S. Application Data
(60) Provisional application No. 61/112,314, filed on Nov. 7, 2008.

(51) Int. Cl. G06F 17/10

(52) U.S. Cl. 703/2

(57) ABSTRACT

Systems and methods for computing a variogram model, which utilize a variogram map and a rose diagram to compute the variogram model. The variogram model may be validated in real-time to provide immediate feedback without the need to interpolate or simulate the real data.

### CROSS-REFERENCE TO RELATED APPLICATIONS

The priority of U.S. Provisional Patent Application No. 61/112,314, filed on Nov. 7, 2008, is hereby claimed, and the specification thereof is incorporated herein by reference. This application and U.S. patent application Ser. No. 12/229,879, which is incorporated herein by reference, are commonly assigned to Landmark Graphics Corporation.

### STATEMENT REGARDING FEDERALLY SPONSORED RESEARCH

Not applicable.

### FIELD OF THE INVENTION

The present invention generally relates to systems and methods for computing and validating a variogram model. More particularly, the present invention relates to validating a variogram model without relying on real data.

### BACKGROUND OF THE INVENTION

Finding a variogram model is one of most important and often difficult tasks in geostatistics/property modeling as it identifies the maximum and minimum directions of continuity of a given geologic or petrophysical property or any spatially correlated property. The “maximum direction of continuity” is the azimuth along which the variance of a given property changes the least. The “minimum direction of continuity” is a direction perpendicular to the maximum direction of continuity, which is the azimuth along which the variance of a given property changes the most.

Conventional methods for the computation and fitting of a traditional semi-variogram often require domain expertise on the part of the user and considerable trial and error. Conventional methods for automated semi-variogram fitting also focus on least squares methods of fitting a curve to a set of points representing an experimental semi-variogram.

Many commercial software packages offer traditional trial and error fitting. In FIG. 1, for example, traditional trial and error semi-variogram modeling is illustrated using ten (10) experimental semi-variograms in a graphical user interface 100. Each experimental semi-variogram is computed along a different azimuth. The number of experimental semi-variograms is dependent on the number of input data points and the number of data pairs in the computation. Ten were chosen for this example and produced satisfactory results based on 261 input data points. The user must experiment with the number of direction, with a minimum of 2 and a maximum of 36; the latter of which is computed every 5 degrees.

In each semi-variogram illustrated in FIG. 1, the user drags a vertical line 102 (left or right) using a pointing device until a line 104 is a “best fit” between the points in each semi-variogram. The user also has a choice of model types such as, for example, spherical, exponential, and Gaussian, when fitting the experimental semi-variogram points. This type of non-linear fitting is available in commercial software packages, such as a public domain product known as “Uncert,” which is a freeware product developed by Bill Wingle, Dr. Eileen Poeter, and Dr. Sean McKenna.

In automated fitting, the concept would also be to fit a curve to the semi-variogram points, but the software would use some approximation of the function to produce the best fit. As illustrated in FIG. 2, for example, traditional automated-linear semi-variogram fittings are compared to each experimental semi-variogram for FIG. 1 in the display 200. The linear best-fit shown in FIG. 2, however, is not very good for most rigorous cases. In most automated cases, the approach requires some form of curve (non-linear) fitting method that is “blind” to the user. An approach is blind to the user when the user cannot give any input to the fit achieved by the automated function.

A variogram model may also be used to perform simulations or interpolations based on selected (real) data. Depending on the size of the selected dataset and the grid mesh being used, either process could take several hours to complete. Moreover, once the selected data has been interpolated or simulated using geostatistical interpolation or geostatistical simulation algorithms, which are well known in the art, the variogram modeling parameters may need to be adjusted for more accurate results. In other words, the results of interpolation or simulation may reveal that the variogram model is not entirely accurate and its parameters need to be adjusted. In this event, the process of interpolation or simulation may require multiple iterations. Either process therefore, can become very time consuming at the expense of tying up the processor. Another type of problem exists when there is very little real data available to compute the variogram model, which inevitably requires multiple adjustments after each interpolation or simulation before the variogram model is validated by the accuracy of the results.

There is therefore, a need for a variogram model that enables non-linear semi-variogram fitting, is not blind to the user and can be automated. Further, there is a need for a means to validate a variogram model without having to interpolate or simulate the selected dataset and which is more efficient than validating the variogram model after interpolating or simulating the selected dataset.

### SUMMARY OF THE INVENTION

The present invention therefore, meets the above needs and overcomes one or more deficiencies in the prior art by providing systems and methods for validating a variogram model without first interpolating or simulating the selected dataset.

In one embodiment, the present invention includes a method for validating a variogram model that comprises: i) selecting variogram modeling parameters for the variogram model; ii) performing an unconditional simulation or a geostatistical interpolation on a computer system; iii) rendering an image of simulated values or interpolated values; iv) displaying the image of simulated values or interpolated values; and iv) determining if the image validates the variogram model.

In another embodiment, the present invention includes a program carrier device for carrying computer executable instructions for validating a variogram model. The instructions are executable to implement: i) selecting variogram modeling parameters for the variogram model; ii) performing an unconditional simulation or a geostatistical interpolation; iii) rendering an image of simulated values or interpolated values; iv) displaying the image of simulated values or interpolated values; and v) determining if the image validates the variogram model.

Additional aspects, advantages and embodiments of the invention will become apparent to those skilled in the art from the following description of the various embodiments and related drawings.

### BRIEF DESCRIPTION OF THE DRAWINGS

The patent or application file contains at least one drawing executed in color. Copies of this patent or patent application publication with color drawing(s) will be provided by the U.S. Patent and Trademark Office upon request and payment of the necessary fee.

The present invention is described below with references to the accompanying drawings in which like elements are referenced with like reference numerals, and in which:

FIG. 1 illustrates traditional trial and error semi-variogram modeling using ten (10) experimental semi-variograms.

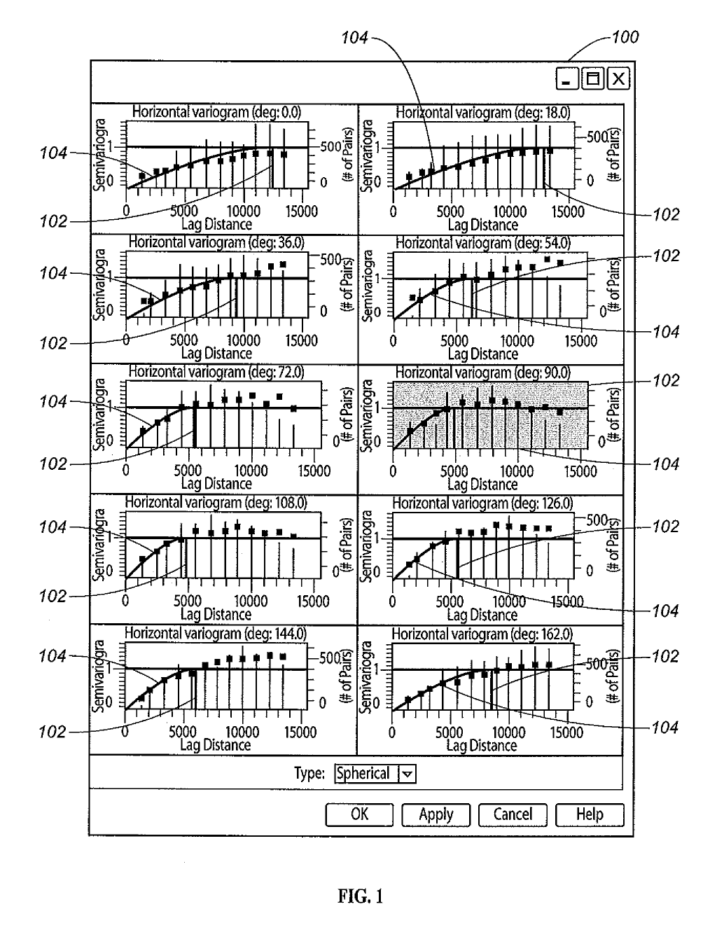

FIG. 2 illustrates traditional automated-linear semi-variogram fittings for each experimental semi-variogram in FIG. 1.

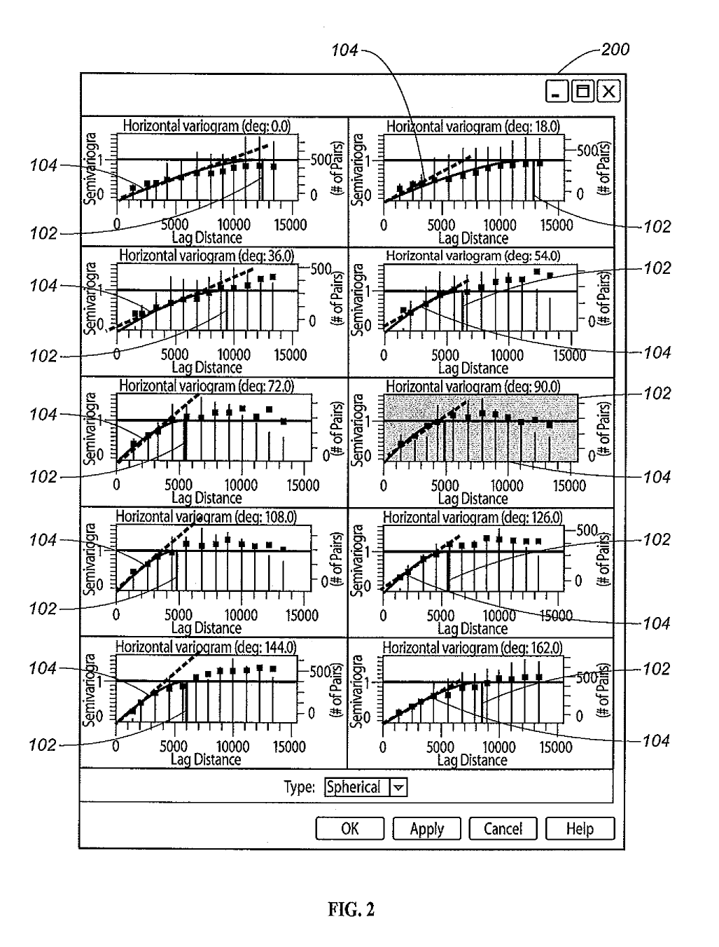

FIG. 3A is a flow diagram illustrating one embodiment of a method for computing a variogram model.

FIG. 3B is a flow diagram illustrating one embodiment of a method for validating a variogram model.

FIG. 4A is a graphical user interface, which illustrates the use of a variogram map and a rose diagram to compute a variogram model and its corresponding semi-variograms according to the method in FIG. 3A.

FIG. 4B is a graphical user interface, which illustrates the analysis of the variogram model using a semi-variogram for each major and minor direction of spatial continuity.

FIG. 4C is a graphical user interface, which illustrates the fields for selecting input data, adjusting the variogram modeling parameters and imaging the variogram model.

FIG. 4D is a graphical user interface, which illustrates the fields for selecting input data, adjusting the variogram modeling parameters and imaging simulated values.

FIG. 4E is a graphical user interface, which illustrates the fields for selecting input data, adjusting the variogram modeling parameters and imaging interpolated values.

FIG. 5 is a block diagram illustrating one embodiment of a system for implementing the present invention.

### DETAILED DESCRIPTION OF THE PREFERRED EMBODIMENTS

The subject matter of the present invention is described with specificity, however, the description itself is not intended to limit the scope of the invention. The subject matter thus, might also be embodied in other ways, to include different steps or combinations of steps similar to the ones described herein, in conjunction with other present or future technologies. Moreover, although the term “step” may be used herein to describe different elements of methods employed, the term should not be interpreted as implying any particular order among or between various steps herein disclosed unless otherwise expressly limited by the description to a particular order.

### Method Description

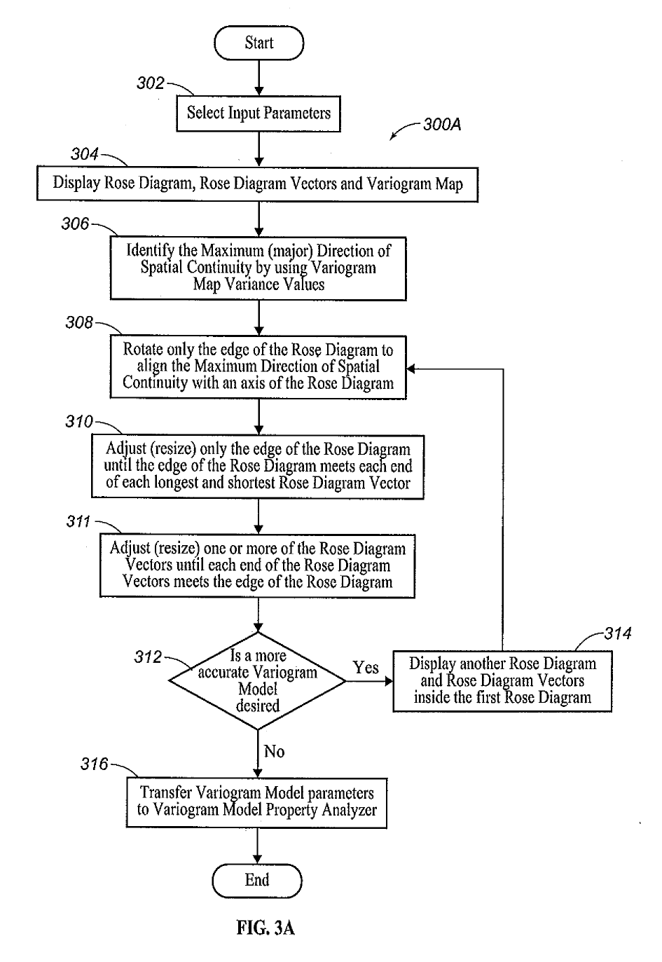

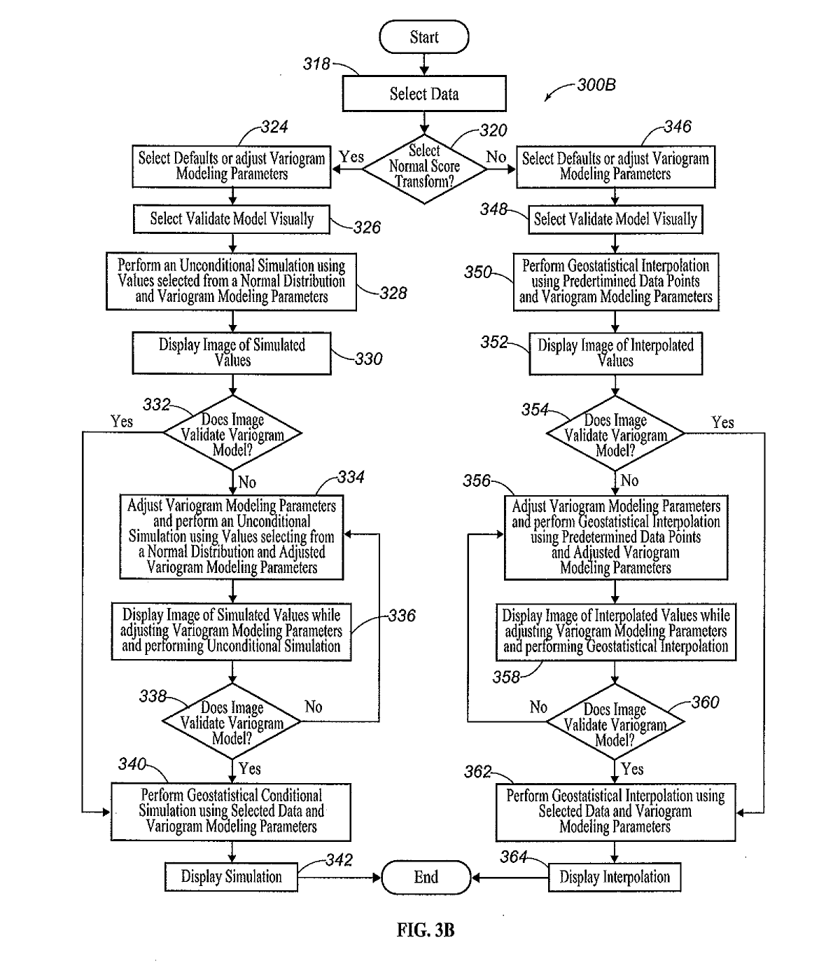

Referring now to FIG. 3A, a flow diagram illustrates one embodiment of a method 300A for computing a variogram model.

In step 302, input parameters are selected using a graphical user interface and techniques well known in the art. The input parameters may be pre-selected as default settings.

In step 304, a rose diagram and variogram map are rendered and displayed using conventional graphic rendering techniques, which are well known in the art. The rose diagram and variogram map are automatically rendered using the input parameters. The variogram map is a polar plot comprising color-coded or gray-scale variance values, which are used to determine a maximum direction of spatial continuity among the data represented by the variogram map. The rose diagram includes an edge and a plurality of vectors, which extend radially away from a center of the rose diagram. The rose diagram and variogram map are preferably concentric. The rose diagram may be a circle with axes of equal length. Optionally, the rose diagram may be an ellipse comprising a major axis, a minor axis and intermediate axes. The variogram map variance values may be computed at specified distances (lag intervals, plus and minus a distance tolerance). The rose diagram represents the distances modeled on the semi-variograms computed along different azimuths. Each line of the rose diagram is the length of the spatial scale modeled on each semi-variogram along the various vectors (number of directions). The variogram map and rose diagram may be used as a graphical representation of the spatial continuity of reservoir properties or any regionalized attribute.

In step 306, the maximum (major) direction of spatial continuity on the variogram map is identified by using the variogram map variance values. The maximum direction of spatial continuity is typically identified as the direction in which the color-coded or gray-scale variance values change the least with distance (lag interval). The minimum (minor) direction of spatial continuity is typically identified as the direction in which the color-coded or gray-scale variance values change the most rapidly with distance, which is usually perpendicular to the maximum direction of spatial continuity.

In step 308, only the edge of the rose diagram is rotated to align the maximum direction of spatial continuity with an axis of the rose diagram using a graphical user interface and techniques well known in the art. If the rose diagram is an ellipse, then the maximum direction of spatial continuity is preferably aligned with the major axis of the rose diagram. If the longest and shortest rose diagram vectors represent the maximum and minimum directions of spatial continuity, respectively, then the rose diagram (ellipse) major and minor axes may be aligned with the longest and shortest rose diagram vectors.

In step 310, only the edge of the rose diagram is adjusted (resized) using a graphical user interface and techniques well known in the art until the edge of the rose diagram meets each end of each longest and shortest rose diagram vector. Adjusting the edge of the rose diagram therefore, may change the shape and size of the rose diagram. At this step, the variogram model may be complete or it may be refined and analyzed by one or more of the following steps.

In step 311, one or more of the rose diagram vectors may be adjusted (resized) until each end of the rose diagram vectors meets the edge of the rose diagram. In this step, each of the one or more rose diagram vectors may be displayed with a respective semi-variogram, which represents the spatial scale or continuity of the property for that vector and may be used to adjust the length of the vector. This step is preferably done without further adjusting the edge of the rose diagram.

In step 312, method 300A determines if a more accurate variogram model is desired. If the variogram model does not require further refinement, then the parameters for the variogram model may be transferred to a Variogram Model Property Analyzer as indicated in step 316. If, however, more accuracy is desired, then another rose diagram may be rendered and displayed inside the first rose diagram at step 314 and the method 300A is repeated for the another rose diagram beginning at step 308. In other words, the variogram model is “nested.” This step allows for more accurate modeling of the near-origin portion of the variogram model.

The method 300A may also be automated, but is quite different than any other approach in that the method can fit nested models. The approach may be automated using a linear or non-linear authorized mathematical function. Authorization means that it is restricted to a small set of functions, which are well known in the art and insure positive-definiteness of the covariance matrix.

The method 300A therefore, intuitively improves the ability to model the scales and orientation of spatial continuity in the data. The method 300A is not blind to the user because it makes use of the variogram map, an associated rose diagram and several authorized model types such as, for example, spherical, cubic and exponential, for variogram modeling. As can be appreciated by those having ordinary skill in the art, the method 300A can be applied to one, two or three-dimensional data sets.

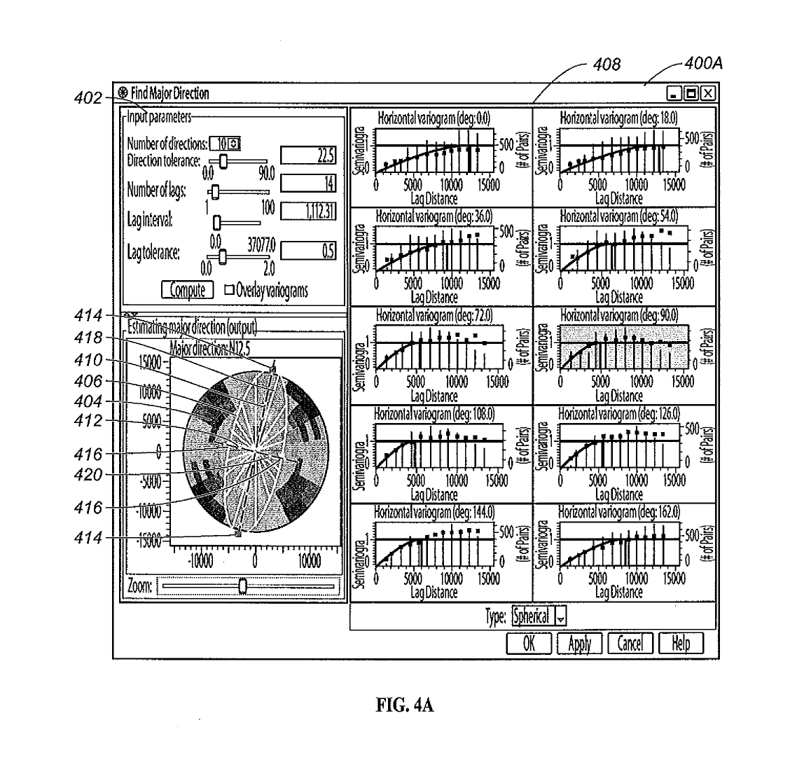

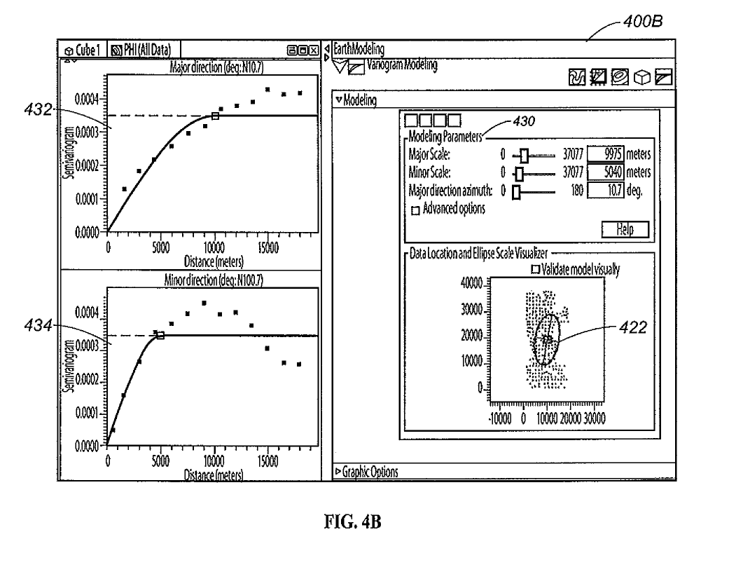

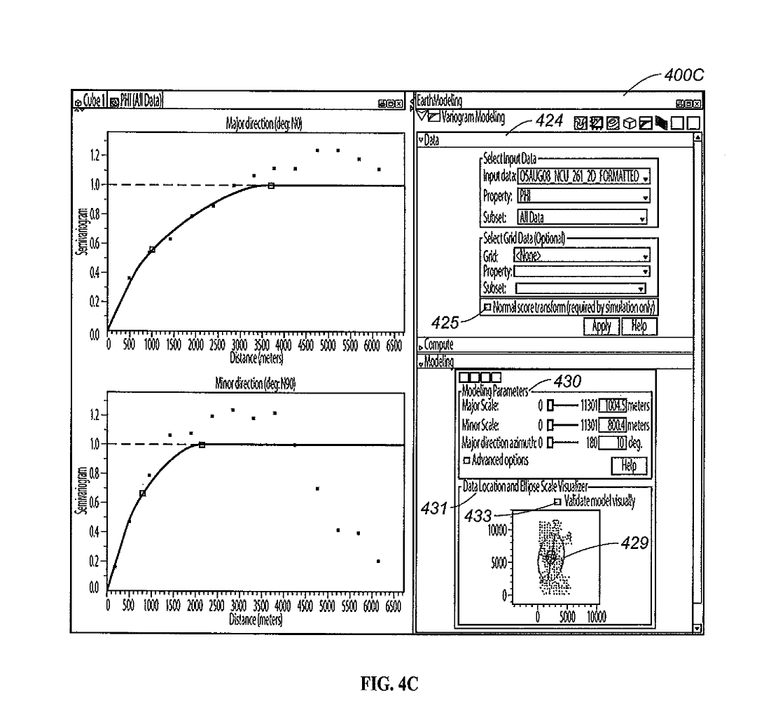

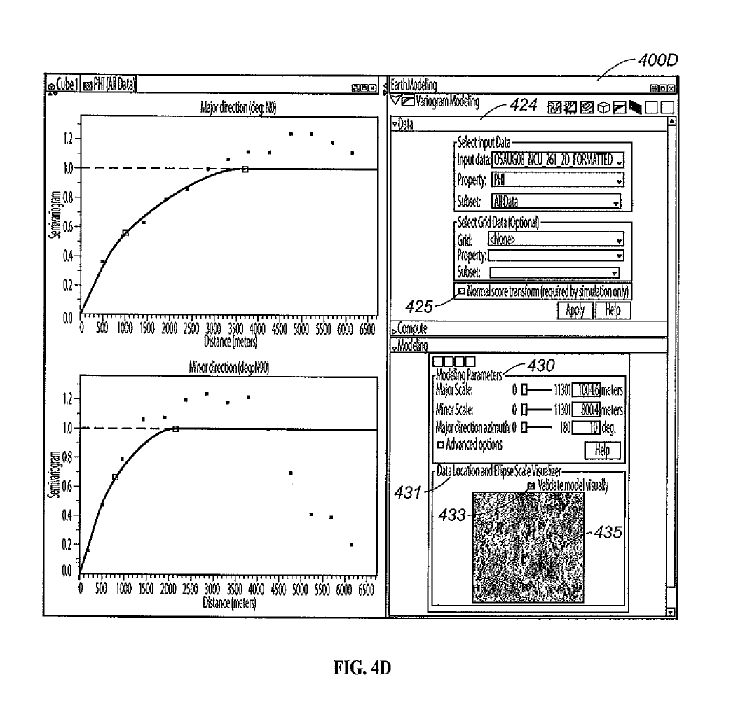

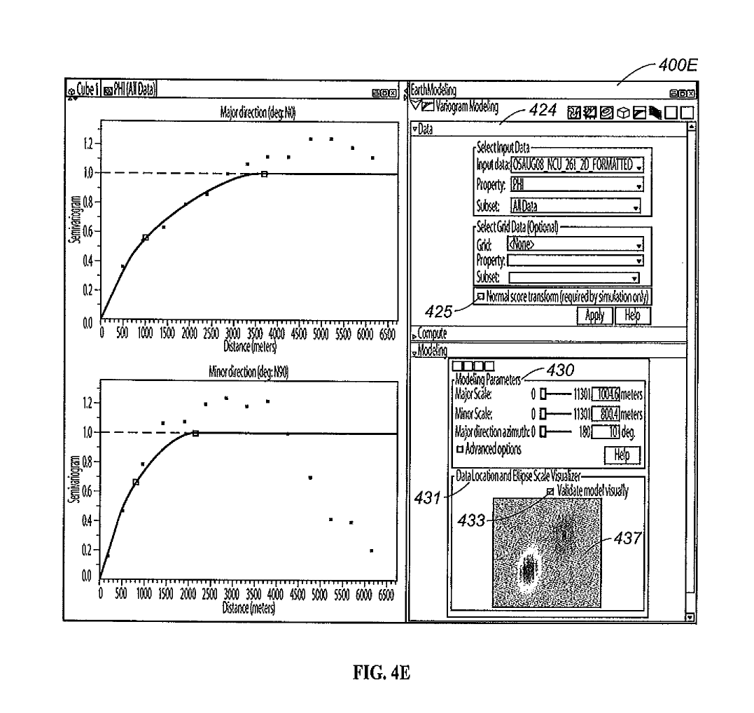

Referring now to FIG. 4A, a conventional graphical user interface 400A illustrates the use of a variogram map and an elliptical rose diagram to intuitively compute a variogram model according to the method 300A in FIG. 3A.

The user first selects the input parameters 402, which control the display of the variogram map 404, the rose diagram 406 and each rose diagram vector extending radially from a center of the rose diagram and the variogram map. The input parameters 402 also control the display of each of the ten (10) semi-variograms in the semi-variogram display 408, which represent the spatial scale or continuity of the property for that vector and may be used to adjust the length of the vector. The input parameters 402 may be pre-selected as default settings, which may vary depending on the data-set. Alternatively, the user may select the number of directions that will determine the number of rose diagram vectors and spacing. The “direction tolerance” is the angular tolerance in degrees along the search vector. The angular tolerance is determined by dividing the number of directions into 180 degrees. The “number of lags” specifies the number of points included in each semi-variogram. The “lag interval” determines the amount of spacing or distance between each data pair used to compute the variance, which is included in each point of the experimental semi-variogram. The user can select the default lag interval (the distance over which computations are made) or a customized lag interval based on experience. The “lag tolerance” is the proportion of the lag interval used in the computation of each corresponding semi-variogram.

Once the input parameters 402 are selected, the user selects “compute” and the program computes and displays the variogram map 404, the rose diagram 406, each rose diagram vector and each corresponding semi-variogram in the semi-variogram display 408. The rose diagram 406 and the variogram map 404 are preferably concentric. As illustrated by the rose diagram 406, there are ten (10) different vectors extending radially from a center of the rose diagram 400 and variogram map 404. Because the variogram map 404 represents the four quadrants of the possible experimental semi-variograms, the NE quadrant is a reversed mirror image of the SW quadrant and the same holds true for the NW and SE quadrants of the variogram map 404. Therefore, the 10 directions appear to be 20 vectors emanating from the center of the rose diagram 406. The length of each vector is related to the “scale” or distance from the y-axis to the position of the best fit on each corresponding semi-variogram in the semi-variogram display 408. In other words, the point at which each vector reaches horizontal (furthest point from the y-axis) on its corresponding semi-variogram corresponds with the edge of the rose diagram 406. Each semi-variogram in the semi-variogram display 408 represents a different direction and thus, a different orientation of the associated vector for the rose diagram 406.

On the variogram map 404, the maximum (major) direction of spatial continuity 410 is identified as the direction in which the color-coded or gray-scale variance values change the least. The minimum (minor) direction of spatial continuity 412 is identified as the direction in which the color-coded or gray-scale variance values change the most rapidly with distance, which is typically perpendicular to the maximum direction of spatial continuity 410.

The user rotates only the edge of the rose diagram 406 to align the maximum direction of spatial continuity 410 with a major axis of the rose diagram 406 by clicking on a handle 414 or 416 with a pointing device.

Once aligned, the user then adjusts (resizes) only the edge of the rose diagram 406, by using the handles 414 or 416 until the edge of the rose diagram 406 meets each end of each longest 418 and shortest 420 rose diagram vector. Adjusting the edge of the rose diagram 406 in this manner will also find the best fit curve for the semi-variograms in the semi-variogram display 408. Once the best fit is found, the variogram model may be complete. Optionally, one or more of the rose diagram vectors may be adjusted (resited) until each end of the rose diagram vectors meets the edge of the rose diagram 406. In this manner, the length of each rose diagram vector may be adjusted, without adjusting the edge of the rose diagram 406, using a corresponding semi-variogram in the semi-variogram display 408.

Once the variogram model is complete, the parameters for the model may be passed on to the Variogram Model Property Analyzer illustrated in FIG. 4B. In FIG. 4B, a conventional graphical user interface 400B illustrates the analysis of the variogram model 422 using a semi-variogram for each major and minor direction of spatial continuity. The user interface 400B illustrates the semi-variograms computed for only the major 432 and minor 434 directions of continuity as determined from the use of the variogram map and rose diagram. The user has the option to accept the final fitted variogram model 422 or can make manual adjustments to the modeling parameters 430 until a satisfactory fit is achieved, using nested models if required.

Once finalized, the variogram model 422 is saved and can then be used to perform interpolation or conditional simulation, which are well known in the art.

Referring now to FIG. 3B, a flow diagram illustrates one embodiment of a method 300B for validating a variogram model.

In step 318, real data may be selected through the graphical user interface 400C illustrated in FIG. 4C. The data field 424 includes a field to select input data and another field to select grid data. These fields may be populated by simple selection of available data.

In step 320, determine whether to select a normal score transform based on the method (interpretation or simulation) desired for a property of the data selected in step 318. If a normal score transform is selected, then the normal score transform box 425 in FIG. 4C is checked and a normal score transform is performed on the real data selected in step 318. A normal score transform generally ranks real data from lowest to highest values, and then matches these ranks to equivalent ranks from a normal distribution. The method 300B then proceeds to step 324 and the variogram model 429 may be validated for geostatistical simulation. A geostatistical simulation, for example, may be preferred when heterogeneity of the data is important. If a normal score transform is not selected, then method 300B proceeds to step 346 and the variogram model 429 may be validated for geostatistical interpolation. In other words, the method 300B proceeds to step 346 as a default if the normal score transform box 425 in FIG. 4C is not checked.

In step 324, defaults for the variogram modeling parameters may be selected or the variogram modeling parameters may be adjusted if the defaults are found to be undesirable. The defaults are simply the variogram modeling parameters that were computed using real data according to the method 300A illustrated in FIG. 3A. The variogram modeling parameters 430 are illustrated in FIG. 4C, which include separate fields for major scale, minor scale and major direction azimuth. The default variogram modeling parameters will appear in these fields. If the default variogram modeling parameters are undesirable because there may be very little real data available to compute an accurate variogram model, the different fields of the variogram modeling parameters 430 including the defaults may be adjusted and set based on the knowledge and expertise of the user. For example, the variogram modeling parameters 430 may be adjusted based on the user's knowledge of the geology, look up tables, and the like.

In step 326, the variogram model 429 may be visually validated by selecting the validate model visually box 433 in the data location and ellipse scale visualizer field 431 of FIG. 4C.

In step 328, an unconditional simulation is performed using values selected from a normal distribution and the default or adjusted variogram modeling parameters from step 324. In this implementation, the data selected in step 318 is not used. Instead, a standard normal histogram is used. The histogram has a mean value equal to zero and a range of values between −3 and +3, which creates a symmetrical distribution (Gaussian or normal distribution) around the mean value. The values selected from the histogram's normal distribution, created by use of the normal score transform, may therefore, be used in the unconditional simulation as if they were values taken from real data. The algorithm used for performing an unconditional simulation is referred to as a sequential Gaussian algorithm, which is well known in the art. Alternatively, other, well known, algorithms may be used to perform an unconditional simulation, which include the Turning Bands or Probability Field algorithms.

In step 330, an image 435 of the simulated values is rendered and displayed in FIG. 4D. In this manner, the variogram model 429 in FIG. 4C, which may be rendered in just a few seconds, may be visually validated by just looking at the image 435. This also enables the user to see what impact the variogram model will have on the data selected in step 318 when the selected data is used for a geostatistical conditional simulation in step 340.

In step 332, determine if the image 435 validates the variogram model 429 by a visual inspection of the image 435 to determine proper orientation and major/minor scales of continuity for the variogram model. If the image 435 does validate the variogram model 429, then the method 300B proceeds to step 340. Otherwise, the method 300B proceeds to step 334.

In step 334, the default or adjusted variogram modeling parameters are adjusted in FIG. 4D and an unconditional simulation is performed in the same manner as described in reference to step 328, but using the variogram modeling parameters adjusted in this step.

In step 336, the image 435 of the simulated values is rendered and displayed in FIG. 4D while adjusting the default or adjusted variogram modeling parameters and performing the unconditional simulation. In this manner, changes to the image 435 of the simulated values are displayed, in real time, while the variogram modeling parameters are adjusted in step 334. As a result, the variogram model 429 may be validated in real time while looking at the image 435.

In step 338, determine if the image 435 validates the variogram model 429 in the same manner as described in reference to step 332. If the image 435 does validate the variogram model 429, then the method 300B proceeds to step 340. Otherwise, the method 300B returns to step 334.

In step 340, a geostatistical conditional simulation is performed using the real data selected in step 318 and the variogram modeling parameters for the validated variogram model. Geostatistical conditional simulation may be performed using the same techniques and algorithms described in reference to step 328 for performing an unconditional simulation, except that the conditional simulation honors the real data where measured. Preferably, another normal score transform is also performed in order to transform the simulated normal score data back into the correct units of the real data.

In step 342, the final simulation of the real data selected in step 318 is rendered and displayed. Because simulations create many possible solutions (realizations) using a single dataset and a variogram model, the display of the final simulation may be used as a final quality control check to confirm that the conditional simulation created the expected results based on the variogram model.

In step 346, defaults for the variogram modeling parameters may be selected or the variogram modeling parameters may be adjusted if the defaults are found to be undesirable. Again, the defaults are simply the variogram modeling parameters that were computed using real data according to the method 300A illustrated in FIG. 3A. If the default variogram modeling parameters are undesirable because there may be very little real data available to compute an accurate variogram model, the different fields of the variogram modeling parameters 430 including the defaults may be adjusted and set based on the knowledge and expertise of the user. For example, the variogram modeling parameters 430 may be adjusted based on the user's knowledge of the geology, lookup tables, and the like.

In step 348, the variogram model 429 may be visually validated by selecting the validate model visually box 433 in the data location and ellipse scale visualizer field 431 of FIG. 4C.

In step 350, geostatistical interpolation is performed using predetermined data points and the default or adjusted variogram modeling parameters from step 346. The predetermined data points are not real data points however, are set by the method 300B and cannot be altered by the user. Preferably, the predetermined data points include five (5) data points with data values however, may include more or less data points with data values depending on the preferences of the user. The data values associated with the predetermined data points may therefore, be used in the interpolation as if they were values taken from real data. The algorithm used for performing geostatistical interpolation is referred to as the kriging algorithm, which is well known in the art. Alternatively, other, well known, algorithms may be used to perform geostatistical interpolation.

In step 352, an image 437 of the interpolated values is rendered and displayed in FIG. 4E. In this manner, the variogram model 429 in FIG. 4C, which may be rendered in just a few seconds, may be visually validated by just looking at the image 437. This also enables the user to see what impact the variogram model will have on the data selected in step 318 when the selected data is used for geostatistical interpolation in step 362.

In step 354, determine if the image 437 validates the variogram model 429 by a visual inspection of the image 437 to determine proper orientation and major/minor scales of continuity for the variogram model. If the image 437 does validate the variogram model 429, then the method 300B proceeds to step 362. Otherwise, the method 300B proceeds to step 356.

In step 356, the default or adjusted variogram modeling parameters are adjusted in FIG. 4E and geostatistical interpolation is performed in the same manner as described in reference to step 350, but using the variogram modeling parameters adjusted in this step.

In step 358, the image 437 of the interpolated values is rendered and displayed in FIG. 4E while adjusting the default or adjusted variogram modeling parameters and performing the geostatistical interpolation. In this manner, changes to the image 437 of the interpolated values are displayed, in real time, while the variogram modeling parameters are adjusted in step 356. As a result, the variogram model 429 may be validated in real time while looking at the image 437.

In step 360, determine if the image 437 validates the variogram model 429 in the same manner as described in reference to step 354. If the image 437 does validate the variogram model 429, then the method 300B proceeds to step 362. Otherwise, the method 300B returns to step 356.

In step 362, a geostatistical interpolation is performed using the real data selected in step 318 and the variogram modeling parameters for the validated variogram model. Geostatistical interpolation may be performed using the same techniques and algorithms described in reference to step 350 for performing geostatistical interpolation.

In step 364, the final interpolation of the real data selected in step 318 is rendered and displayed. Because geostatistical interpolation creates only one result based on a single dataset and a variogram model, the display of the final interpolation may be used as a final quality control check to confirm that the interpolation created the expected results based on the variogram model.

The workflow represented in FIG. 3B (steps 346-364) was incorporated into an improved workflow for creating/validating variogram models based on a property (interpolated porosity) for the selected data and compared to a conventional workflow for creating/validating variogram models based on the same property and the same data. The comparison was made using default variogram modeling parameters and adjusted (custom) variogram modeling parameters. The comparison results are reflected in Table 1 hereinbelow. As demonstrated by the results in Table 1, the improved workflow is significantly more efficient than the conventional workflow. In fact, the improved workflow reduced the time represented to validate the horizontal and vertical variograms by nearly 50% in each case. In order to conduct the comparison, real data was used. The real data was obtained by permission from Amoco.

TABLE 1

| Default Variogram | | | | Adjusted Variogram | | | |
|---|---|---|---|---|---|---|---|
| Modeling Parameters | | | | Modeling Parameters | | | |
| | | Conventional | | | | Conventional | |
| Improved Workflow | | Workflow | | Improved Workflow | | Workflow | |
| | Time | | Time | | Time | | Time |
| | (nearest | | (nearest | | (nearest | | (nearest |
| Operations | min.) | Operations | min) | Operations | min) | Operations | min) |
| Horizontal and | 18 | Horizontal and | 31 | Horizontal and | 31 | Horizontal and | 56 |
| vertical vario- | | vertical vario- | | vertical vario- | | vertical vario- | |
| grams validated | | grams validated | | grams validated | | grams validated | |

### System Description

The present invention may be implemented through a computer-executable program of instructions, such as program modules, generally referred to software applications or application programs executed by a computer. The software may include, for example, routines, programs, objects, components, data structures, etc., that perform particular tasks or implement particular abstract data types. The software forms an interface to allow a computer to react according to a source of input. DecisionSpace®, which is a commercial software application marketed by Landmark Graphics Corporation, may be used as an interface application to implement the present invention. The software may also cooperate with other code segments to initiate a variety of tasks in response to data received in conjunction with the source of the received data. The software may be stored and/or carried on any variety of memory such as CD-ROM, magnetic disk, bubble memory and semiconductor memory (e.g., various types of RAM or ROM). Furthermore, the software and its results may be transmitted over a variety of carrier media such as optical fiber, metallic wire and/or through any of a variety of networks, such as the Internet.

Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The present invention may therefore, be implemented in connection with various hardware, software or a combination thereof, in a computer system or other processing system.

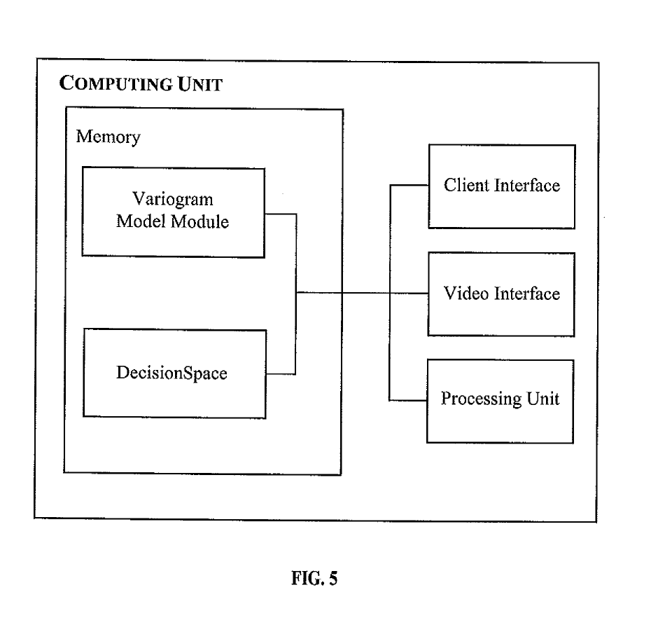

Referring now to FIG. 5, a block diagram of a system for implementing the present invention on a computer is illustrated. The system includes a computing unit, sometimes referred to as a computing system, which contains memory, application programs, a client interface, a video interface and a processing unit. The computing unit is only one example of a suitable computing environment and is not intended to suggest any limitation as to the scope of use or functionality of the invention.

The memory primarily stores the application programs, which may also be described as program modules containing computer-executable instructions, executed by the computing unit for implementing the present invention described herein and illustrated in FIGS. 3A, 3B and FIGS. 4A-4D.

Although the computing unit is shown as having a generalized memory, the computing unit typically includes a variety of computer readable media. By way of example, and not limitation, computer readable media may comprise computer storage media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to and/or are presently being operated on by the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through an application program interface (“API”), which may reside on a separate computing unit connected through a computer system or network. For example only, a hard disk drive may read from or write to nonremovable, nonvolatile magnetic media, a magnetic disk drive may read from or write to a removable, non-volatile magnetic disk, and an optical disk drive may read from or write to a removable, nonvolatile optical disk such as a CD ROM or other optical media. Other removable/non-removable, volatile/non-volatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above therefore, store and/or carry computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well known.

The system and methods of the present invention therefore, improve computing and validating a variogram model for geostatistical modeling. Various alternatives and/or modifications may be made to the disclosed embodiments without departing from the spirit or scope of the invention. The present invention, for example, may be used in other applications outside of the oil and gas industry to visually validate variogram models. The present invention, for example, may be used with any type of data that is considered to be a regionalized variable or with any property that has spatial coordinates affiliated with a property measurement. Other industry applications may include:
environmental studies of trace metals, toxins;
mapping the quantity and quality of coal and its potential contaminants such as sulfur and mercury;
measuring signal strength in the cellular phone industry;
creating maps of aquifers;
mapping soil patterns; and
analyzing and predicting rainfall using Doppler Radar and rainfall measurements.

While the present invention has been described in connection with presently preferred embodiments, it will be understood by those skilled in the art that it is not intended to limit the invention to those embodiments. It is therefore, contemplated that various alternative embodiments and modifications may be made to the disclosed embodiments without departing from the spirit and scope of the invention defined by the appended claims and equivalents thereof.

1. A method for validating a variogram model, which comprises:
selecting variogram modeling parameters for the variogram model;
performing an unconditional simulation or a geostatistical interpolation on a computer system;
rendering an image of simulated values or interpolated values;
displaying the image of simulated values or interpolated values; and
determining if the image validates the variogram model.

2. The method of claim 1, further comprising:
selecting input data; and
performing the unconditional simulation or the geostatistical interpolation based on a property for the selected input data.

3. The method of claim 1, wherein the unconditional simulation is performed using values selected from a normal distribution and the variogram modeling parameters.

4. The method of claim 1, wherein the geostatistical interpolation is performed using predetermined data points and the variogram modeling parameters.

5. The method of claim 1, further comprising:
adjusting the variogram modeling parameters; and
performing another unconditional simulation using values selected from a normal distribution and the adjusted variogram modeling parameters.

6. The method of claim 1, further comprising:
adjusting the variogram modeling parameters; and
performing another geostatistical interpolation using predetermined data points and the adjusted variogram modeling parameters.

7. The method of claim 5, further comprising:
displaying another image of simulated values while adjusting the variogram modeling parameters and performing the another unconditional simulation;
determining if the another image validates the variogram model; and
repeating the steps of displaying another image of simulated values and determining if the another image validates the variogram model until the another image validates the variogram model.

8. The method of claim 6, further comprising:
displaying another image of interpolated values while adjusting the variogram modeling parameters and performing the another geostatistical interpolation;
determining if the another image validates the variogram model; and
repeating the steps of displaying another image of interpolated values and determining if the another image validates the variogram model until the another image validates the variogram model.

9. The method of claim 2, further comprising:
performing a geostatistical conditional simulation or another geostatistical interpolation using the selected input data and the variogram modeling parameters; and
displaying an image of the geostatistical conditional simulation or the another geostatistical interpolation.

10. The method of claim 1, wherein determining if the image validates the variogram model comprises:
comparing the image and the variogram model to confirm whether the variogram model is properly oriented and includes a proper major scale of continuity and a proper minor scale of continuity.

11. A program carrier device for carrying computer executable instructions for validating a variogram model, which comprises:
selecting variogram modeling parameters for the variogram model;
performing an unconditional simulation or a geostatistical interpolation;
rendering an image of simulated values or interpolated values;
displaying the image of simulated values or interpolated values; and
determining if the image validates the variogram model.

12. The program carrier device of claim 11, further comprising:
selecting input data; and
performing the unconditional simulation or the geostatistical interpolation based on a property for the selected input data.

13. The program carrier device of claim 11, wherein the unconditional simulation is performed using values selected from a normal distribution and the variogram modeling parameters.

14. The program carrier device of claim 11, wherein the geostatistical interpolation is performed using predetermined data points and the variogram modeling parameters.

15. The program carrier device of claim 11, further comprising:
adjusting the variogram modeling parameters; and
performing another unconditional simulation using values selected from a normal distribution and the adjusted variogram modeling parameters.

16. The program carrier device of claim 11, further comprising:
adjusting the variogram modeling parameters; and
performing another geostatistical interpolation using predetermined data points and the adjusted variogram modeling parameters.

17. The program carrier device of claim 15, further comprising:
displaying another image of simulated values while adjusting the variogram modeling parameters and performing the another unconditional simulation;
determining if the another image validates the variogram model; and
repeating the steps of displaying another image of simulated values and determining if the another image validates the variogram model until the another image validates the variogram model.

18. The program carrier device of claim 16, further comprising:
displaying another image of interpolated values while adjusting the variogram modeling parameters and performing the another geostatistical interpolation;
determining if the another image validates the variogram model; and
repeating the steps of displaying another image of interpolated values and determining if the another image validates the variogram model until the another image validates the variogram model.

19. The program carrier device of claim 12, further comprising:
performing a geostatistical conditional simulation or another geostatistical interpolation using the selected input data and the variogram modeling parameters; and
displaying an image of the geostatistical conditional simulation or the another geostatistical interpolation.

20. The program carrier device of claim 11, wherein determining if the image validates the variogram model comprises:
comparing the image and the variogram model to confirm whether the variogram model is properly oriented and includes a proper major scale of continuity and a proper minor scale of continuity.
